(19) United States
(12) Patent Application Publication
(10) Pub. No.: US 2020/0213477 A1
(43) Pub. Date: Jul. 2, 2020

(54) IMAGE PROCESSING APPARATUS, COLOR CONVERSION METHOD, AND COLOR CONVERSION PROGRAM

(71) Applicant: Konica Minolta Inc., Tokyo (JP)

(72) Inventor: SACHIKO HIRANO, Tokyo (JP)

(21) Appl. No.: 16/705,302

(22) Filed: Dec. 6, 2019

(30) Foreign Application Priority Data
Dec. 27, 2018 (JP) 2018-244028

(51) Int. Cl. H04N 1/64; H04N 1/60

(52) U.S. Cl. CPC H04N 1/642; H04N 1/6094

(57) ABSTRACT

Provided is an image processing apparatus that compares a color sample image and a document image, and performs color adjustment at a time of output of the document image, the image processing apparatus includes: storage that stores a color sample image and a document image; and a control part that compares the color sample image and the document image, and performs color adjustment, wherein the control part extracts a continuous region having a predetermined level or more of uniformity for a predetermined item, on the color sample image and the document image, compares accompanying information of each of images in the region, and selects a region of the color sample image corresponding to the region of the document image on the basis of a result of the comparison.

The entire disclosure of Japanese patent Application No. 2018-244028, filed on Dec. 27, 2018, is incorporated herein by reference in its entirety.

### BACKGROUND

### Technological Field

The present invention relates to an image processing apparatus, a color conversion method, and a color conversion program to achieve matching in an output color of a document image with a color sample image as a color sample.

### Description of the Related Art

In an image forming device or the like, there is a case where color adjustment is performed to achieve matching in the output color of document data on an on-demand machine or the like, using a primed product as a sample (=print sample)

For example, as disclosed in JP 2016-139867 A, there is a disclosed method in which a target colorimetric value is obtained from a scanned image of a sample and an automatic adjustment is performed so that pixels at the same position in the document data will have a desired color.

Meanwhile, the color sample may be (in case of reprinting, etc.) or may not always be the same content as the document data (as illustrated in FIG. 5, this corresponds to a case where the printed product is a series product, having (1) a positional difference in a logo mark or the like (2) a background having different texts, (3) different text strings such as “September/October” or the like, so that the color matches the color of the sample).

However, in JP 2016-139867 A is described on the presumption that the color sample and the document have the same content, and thus, disables color adjustment in a case where the color sample and the document do not match.

As another example, JP 2007-535829 A discloses a method for matching colors of images having different content. In this, target extraction for color matching is determined by frequency (pixels) of emergence of the color in an image and pattern matching. This involves a problem of occurrence of erroneous extraction in the case where there is a difference between “sample and document” as described above, and in particular, where there are few common parts.

### SUMMARY

The present invention has been made in view of the above circumstances as a background, and aims to provide an image processing apparatus and a color conversion method and a color conversion program capable of color adjustment by extracting an object of color matching without erroneous detection even in a case where there is a difference between the sample and the document.

To achieve the abovementioned object, according to an aspect of the present invention, there is provided an image processing apparatus that compares a color sample image and a document image, and performs color adjustment at a time of output of the document image, and the image processing apparatus reflecting one aspect of the present invention comprises: storage that stores a color sample image and a document image; and a control part that compares the color sample image and the document image, and performs color adjustment, wherein the control part extracts a continuous region having a predetermined level or more of uniformity for a predetermined item, on the color sample image and the document image, compares accompanying information of each of images in the region, and selects a region of the color sample image corresponding to the region of the document image on the basis of a result of the comparison.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating a control block including an image processing apparatus according to an embodiment of the present invention;

FIG. 2 is a flowchart illustrating a procedure for color adjustment according to an embodiment of the present invention;

FIG. 3 is a table illustrating an example of weighting for each of items according to an embodiment of the present invention;

FIG. 4 is a view illustrating a user interface for performing preview display of a color sample image and a document image, color sample adoption input, or the like, according to an embodiment of the present invention; and

FIG. 5 is a view illustrating an example in which a color sample and a document are partially different.

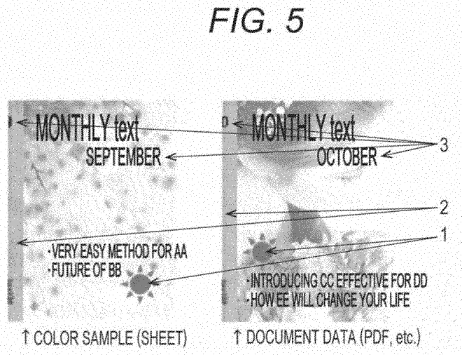

### DETAILED DESCRIPTION OF EMBODIMENTS

Hereinafter, one or more embodiments of the present invention will be described with reference to the drawings. However, the scope of the invention is not limited to the disclosed embodiments.

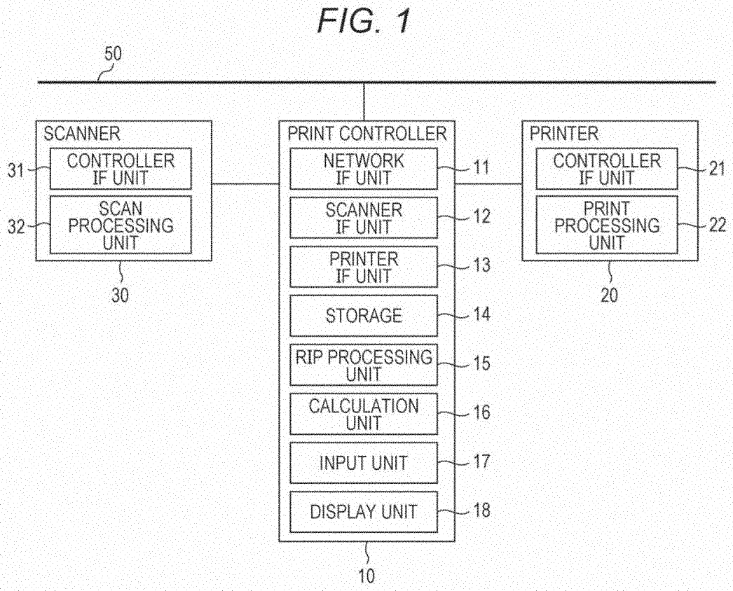

FIG. 1 is a diagram illustrating a control block of an image processing system configuration and includes a network-connectible print controller 10, together with a printer 20 and a scanner 30 connected to the print controller 10. The configuration is not limited to the above as long as necessary functions are provided. For example, the print controller 10 may be included in the printer 20, and the scanner 30 may be connected to the print controller 10 through a network 50.

The print controller 10 includes: a network IF unit 11 to connect to the network 50; a RIP processing unit 15 that includes a calculation unit 16 that perform color conversion (using an ICC profile, for example) to enable an output product to match the desired color, interprets a description language of the input data, and creates image data to be transmitted to the printer 20; a scanner IF unit 12 connected to the scanner; a printer IF unit 13 that instructs the printer 20 a method to transmit and output image data, and storage 14 that stores image data and various types of information. The calculation unit 16 does not have to be included in the RIP processing unit 15. The calculation unit 16 further performs various types of processing on a sample image and document data and performs automatic color matching target extraction according to the present embodiment.

In the present embodiment, the print controller 10 corresponds to the image processing apparatus according to the present invention, while the calculation unit 16 corresponds to the control part of the present invention.

The print controller 10 includes: a display unit 18 that displays an extracted color matching target; and an input unit 17 that receives a user's input of whether color matching is to be adopted. The input unit 17 and the display unit 18 may be shared with RIP processing or the like, and do not have to be disposed in the print controller 10. For example, the input unit 17 and the display unit 18 may be disposed in a separate PC that can be connected to a network and may operate in cooperation with the print controller 10.

The printer 20 is an image forming device that performs printing on the basis of an instruction from the print controller 10. The printer 20 includes a controller I/F unit 21 for communicating with the print controller 10, and a print processing unit 22 that performs image formation in accordance with a print instruction. The print processing unit 22 may separately perform any correction in order to stabilize image formation.

The scanner 30 is a device that scans a document on the basis of an instruction from the print controller 10 and generates digital data. The scanner 30 includes a controller I/F unit 31 for communicating with the print controller 10, and a scan processing unit 32 that performs image formation in accordance with an instruction, or the like. The scanner 30 may perform any correction separately.

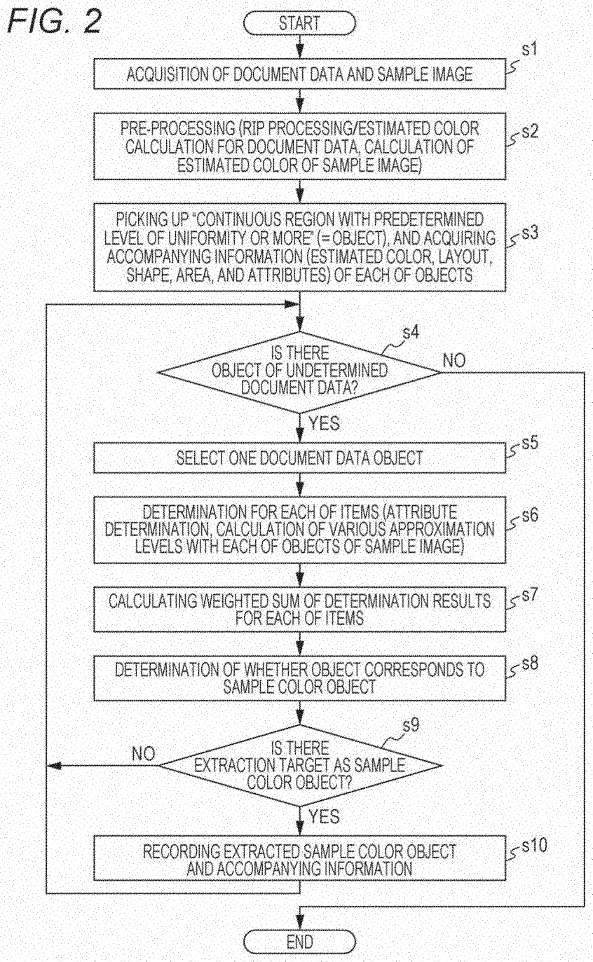

Next, a procedure for color adjustment using “document data” and a “sample image” that at least partially does not match the content of “sample image” acquired from a color sample will be described with reference to the flowchart of FIG. 2. The following procedure can be implemented by the print controller, and control can be executed by the calculation unit.

1. Acquisition of Document Data and Sample Image (Step s1)

In this step, “document data” and “sample image” designated by time user are received. Examples of the document data include PostScript (registered trademark) data or PDF (registered trademark) data created by various DTP applications. The sample image is produced as digital data obtained by scanning, using a scanner, a printed sheet (for example, an actual cover page of the previous month issue of a magazine or tile color calibration output on which color reproduction agreement is obtained from a print orderer when the previous month issue is printed). For example, the sample image is formed of bitmap data in device values such as RGB values.

2. Pre-Processing (RIP Processing and Estimated Color Calculation for Document Data, and Estimated Color Calculation for Sample Image) (Step s2)

RIP processing is performed on the document data. At this time, color conversion is performed in accordance with the setting. Necessary setting content (for example, rendering intent) and necessary data (for example, ICC profile) are separately acquired by any method. After data processing, for example, the document data is processed into bitmap data including device values such as CMYK values and is converted to a resolution that can be compared with the digital data of time sample image by any known method.

In addition, the estimated color of each of pixels of the document data is calculated. Any method or accuracy improvement technique may be used. For example, each of pixel values (for example, CMYK values) after color conversion and a printer profile will be used. Time estimated color is a device-independent color, for example CIE L*a*b*.

Furthermore, it is allowable to
Interpret the description language and identify the pixels occupied by the graphics generated from individual units of the description (postscript, for example), and
Interpret the description language and specify the attributes (for example, text/graphic/image) of each of pixels.

Furthermore, the estimated color of each of pixels of the digital data of the sample image is calculated. Any method or accuracy improvement technique may be used. For example, the acquired device value (for example, RGB value) and the scanner profile are used. The estimated color is a device-independent color, for example CIE L*a*b*.

3. Picking Up “Continuous Region With a Predetermined Level of Uniformity or More” (=Object), and Acquiring Accompanying Information (Estimated Color, Layout, Shape, Area, and Attributes) of Each of Objects (Step s3)

Data obtained by performing RIP processing on the document data obtained in 2, and digital data of the sample image are individually analyzed by any known method. When a continuous region in which the uniformity is a predetermined level or more (for example, a maximum difference of R, G, and B or a maximum difference of C, M, Y, and K is a threshold or below in each of RGB value/CMYK value, respectively) is successfully detected, the region will be determined to be an “object”.

Next, the following will be acquired for each of objects, and be stored in association with the object.
Estimated color (e.g. mean and mode of an estimated color of the corresponding pixel)
Layout (for example, a distance of a specific position (top/bottom/left/right edge/center) of the object from a specific position (top/bottom/left/right edge/center) on an entire image (alignment may be performed at any known method in a case where the document and the sample have different image sizes depending on the presence or absence of bleeds or trimming marks, or the like), or a distance ratio)
Shape (height/width of object or thickness of linear structure part)
Area
Object type described in attribute (PostScript (registered trademark) or PDF (registered trademark)) for the “document data” object.

4. Is There an Object (a Region) of Undetermined Document Data. (Step s4)

When there is no undetermined document data region, the procedure is finished. In a case where there is an undetermined document data region, the procedure proceeds to the next step.

5. Selecting One Document Data Object (Region) (Step s5)

Extraction determination is made as to whether each of objects of the sample image corresponds to the “sample color”, for each of document data objects. (Methods of combining processing procedures are not limited to this as long as all objects can be ultimately checked.

6. Determination for Each of Items (Attribute Determination, Calculation of Various Approximation Levels With Each of Objects of the Sample Image) (Step s6)

For one selected document data object,

the following will be calculated.
Attribute of object in “document data” and
Approximation level of estimated color between “document data” and “sample image”
Approximation level of layout between “document data” and “sample image”
Approximation level of shape between “document data” and “sample image” and
Approximation level of area between “document data” and “sample Image”,
   for each of objects in the sample image.

7. Calculating Weighted Sum of Determination Results for Each of Items (Step s7)

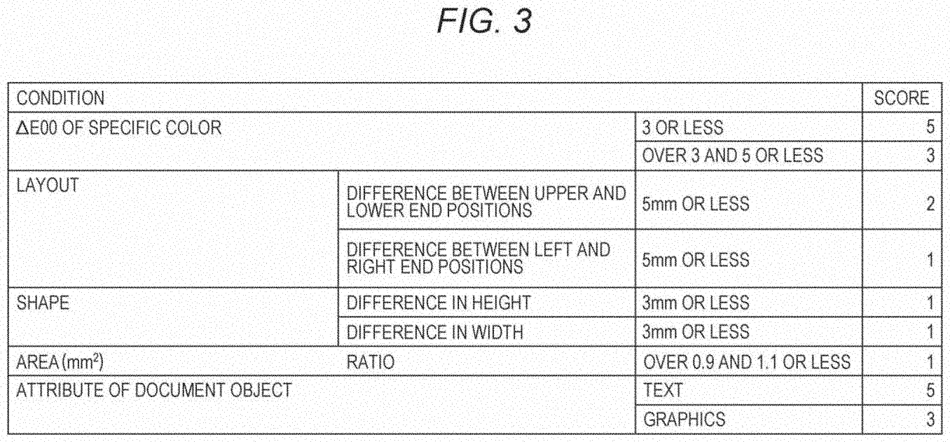

Weighted sum of the determination results for each of items are calculated. FIG. 3 is an example of weighting, in which corresponding scores are added up after checking each of items.

8. Determination of Whether the Object Corresponds to the Sample Color Object (Step s8)

When the weighted sum is a threshold (for example, 13) or more, the object will be extracted as a “sample color”. A plurality of thresholds may be used and the user may select in advance as “extraction level narrow/medium/wide” (level of “wide” indicates lower threshold).

9. Is There an Extraction Target as a Sample Color Object. (Step s9)

In a case where there is an extraction target as a sample color object, the processing proceeds to the next step. In a case where there is no extraction target as a sample color object, the processing returns to step s4 and the procedure will be repeated until there is no target object.

10. Recording Extracted Sample Color Object and Accompanying Information, the Estimated Color in Particular, in Association with The Document Object (Step s10).

Thereafter, the processing returns to step s4, and the procedure will be repeated until there are no more target objects.

FIG. 3 illustrates a table in which each of items is weighted as described above.

In the first row, the score of five is given for 3 or less, and the score of three is given for more than 4 and 5 or less in accordance with color difference ΔE00 of the specific color.

In the second row for layout, the score of two is given in a case where the difference between the upper and lower end positions is 5 mm or less, and the score of one is given in a case where the difference between the left and right end positions is 5 mm or less.

In the third row for the shape, one score of is given for a height difference of 3 mm or less, and one score is given for a width difference of 3 mm or less.

In the fourth row, the score of one is given for the area ratio over 0.9 and 1.1 or less.

In the fifth row, five scores are given in a case where the attribute of the document object is text, and three scores are given when it is graphics.

A sample color object corresponding to the document object may be presented to the user. It is possible to adopt any method such as displaying the document and sample images side by side on the display unit and marking on the images. Furthermore, the user may be allowed to input whether to adopt the marked correspondence as a sample color for color adjustment.

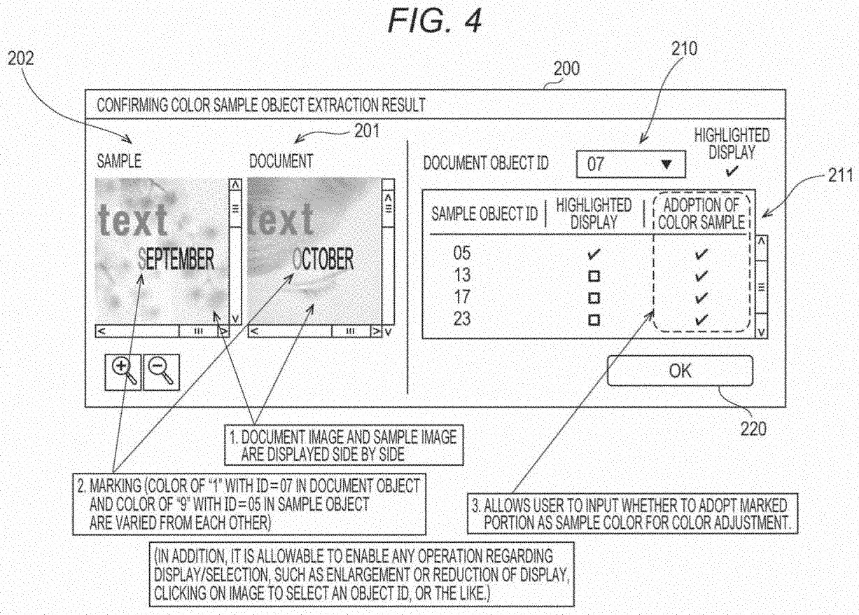

FIG. 4 illustrates a user interface 200, which has a function as a display unit as well as an input unit.

In the screen on the left, a sample image field 202 and a document image field 201 are displayed side by side as preview images, having partial difference in the images. That is, portions having a difference are marked, specifically, the color of “1” with ID=07 in the document object and the color of “9” with ID=05 in the sample object are varied from each other.

The image on the right side includes a display of an ID number field 210 for displaying the ID number of the document object. In this example, “07” is displayed in this field.

Below this, a sample object ID field, a highlighted display check field, and a color sample adoption check field are displayed as a list 211. The regions to display can be changed by a slide bar. In the color sample adoption check, the user can check to input whether to adopt the sample color for color adjustment. The object not having been checked will not be adopted as a sample color for color adjustment.

In addition, it is allowable to enable any operation regarding display/selection, such as enlargement or reduction of display, clicking on an image to select an object ID, or the like.

In color conversion update, a color conversion profile is rewritten so that the estimated color (device-independent color) of the extracted sample color object reaches a target color for the pixel value (device-dependent color) of the corresponding document object in accordance with the extracted correspondence (or the correspondence adopted by the user). Other methods capable of equivalent color matching may also be used.

According to the present embodiment, even when the color sample and the document data have content different from each other and have few common parts in the content, it is possible to extract, without error, the sample color corresponding to the region to undergo color matching on the document data by using information including the layout/shape/area/document object attribute, in addition to the estimated color.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image processing apparatus that compares a color sample image and a document image, and performs color adjustment at a time of output of the document image, the image processing apparatus comprising:
storage that stores a color sample image and a document image; and
a control part that compares the color sample image and the document image, and performs color adjustment,
wherein the control part extracts a continuous region having a predetermined level or more of uniformity for a predetermined item, on the color sample image and the document image, compares accompanying information of each of images in the region, and selects a region of the color sample image corresponding to the region of the document image on the basis of a result of the comparison.

2. The image processing apparatus according to claim 1, wherein the control part extracts, as the predetermined item, a continuous region having a predetermined level or more of uniformity for a color included in each of the document image and the color sample image.

3. The image processing apparatus according to claim 2, wherein the control part determines the level of color uniformity on the basis of pixel values included in the document image and the color sample image.

4. The image processing apparatus according to claim 1,
wherein the control part performs selection of the region of the color sample image by using one or more of the following, as comparison of accompanying information in the extracted region:
Approximation level of an estimated color between the document image and the color sample image is a predetermined level or more;
Approximation level of layout between the document image and the color sample image is a predetermined level or more;
Approximation level of shape between the document image and the color sample image is a predetermined level or more;
Approximation level of area between the document image and the color sample image is a predetermined level or more; and
Attribute of the object in the document image is text or graphics.

5. The image processing apparatus according to claim 4, wherein the control part
performs determination by a device-independent color in a case where the estimated color is used as accompanying information,
performs determination by a distance from a specific position in a region or a distance ratio in the document image or a color sample image in a case where the layout is used as accompanying information,
performs determination by a height or a width of a region, or a thickness of a linear structure in a case where the shape is used as accompanying information,
performs determination by area of a region or an area ratio of the region to an entire surface of the document image or the color sample image in a case where the area is used as accompanying information, and
performs determination by an object type in a case where an attribute of the region in the document image is used as accompanying formation.

6. The image processing apparatus according to claim 5, wherein the control part is required to determine whether the approximation level of the estimated color between the document image and the color sample image is a predetermined level or more, as a result of the comparison of accompanying information.

7. The image processing apparatus according to claim 6, wherein the control part performs color adjustment so that the estimated color in the selected region of the color sample image reaches a target color of the pixel value in a corresponding document image region. 8, The image processing apparatus according to claim 1, wherein, when making a determination using a plurality of items of the accompanying information, the control part weights a result of each of determination items and makes an overall determination.

9. The image processing apparatus according to claim 8, wherein the control part provides a plurality of levels of thresholds for the overall determination from which a user can make a selection.

10. The image processing apparatus according to claim 1, wherein the control part displays a region of a selected color sample image and requests a user to confirm whether color adjustment is to be adopted.

11. The image processing apparatus according to claim 10, wherein the control part learns a user's input result regarding the adoption of color adjustment and learns an automatic determination result, and makes adjustment so that the automatic determination result approaches the user's input regarding the adoption.

12. The image processing apparatus according to claim 1, wherein the color sample image does not include shape/attribute information of a region.

13. The image processing apparatus according to claim 1, wherein the document image and the color sample image have different color space values or different device values.

14. A color adjustment method of comparing a color sample image and a document image and performing color adjustment at a time of output of the document image, the color adjustment method comprising:
acquiring a color sample image and a document image;
extracting a continuous region having a predetermined level or more of uniformity for a predetermined item, on the color sample image and the document image; and
comparing accompanying information of each of images in the region and selecting a region of the color sample image corresponding to the region of the document image on the basis of a result of the comparison.

15. The color adjustment method according to claim 14, wherein the color adjustment is performed so that the estimated color in the selected region of the color sample image reaches a target color of the pixel value in a corresponding document image region.

16. A non-transitory recording medium storing a computer readable color adjustment program to be executed on an image processing apparatus that compares a color sample image and a document image and performs color adjustment at a time of output of the document image, the program causing the image processing apparatus to execute:
storing a color sample image and a document image;
extracting a continuous region having a predetermined level or more of uniformity for a predetermined item, on the color sample image and the document image; and
comparing accompanying information of each of images in the region and selecting a region of the color sample image corresponding to the region of the document image on the basis of a result of the comparison.

17. The non-transitory recording medium storing a computer readable color adjustment program according to claim 16, the program further comprising
performing color adjustment so that the estimated color in the selected region of the color sample image reaches a target color of the pixel value in a corresponding document image region.
